(19) United States
(12) Patent Application Publication
(10) Pub. No.: US 2024/0257218 A1
(43) Pub. Date: Aug. 1, 2024

(54) APPARATUS AND METHOD FOR SUGGESTING USER-RELEVANT DIGITAL CONTENT USING EDGE COMPUTING

(71) Applicant: Mocha Holdings LLC, New York, NY (US)

(72) Inventor: Jonathan Vaughan, Surrey (GB)

(21) Appl. No.: 18/566,005

(22) PCT Filed: Jun. 2, 2022
(86) PCT No.: PCT/US22/31985

§ 371 Date: Nov. 30, 2023

Related U.S. Application Data
(60) Provisional application No. 63/196,444, filed on Jun. 3, 2021.

(51) Int. Cl. G06Q 30/0601

(52) U.S. Cl. CPC G06Q 30/0631

(57) ABSTRACT

Systems, devices, and methods for suggesting user-relevant digital content for commercial products and services is disclosed and may include: receiving one or more user inputs into a computing device; receiving system parameters comprising at least one of: sensor data from one or more sensors in the computing device and information associated with a process on the computing device; utilizing, at the computing device, a machine learning model to determine a situational context based on the received one or more user inputs and the received system parameters; and based on the determined situational context, determining, at the computing device, one or more information items stored in a local content database.

### CROSS-REFERENCE TO RELATED APPLICATION

This application is a 35 U.S.C. § 371 National Stage Entry of International Application No. PCT/US2022/031985 filed Jun. 2, 2022, which claims the priority benefit of U.S. Provisional Patent Application Ser. No. 63/196,444 filed Jun. 3, 2022, incorporated herein by reference in its entirety.

### FIELD OF ENDEAVOR

The invention relates to artificial intelligence, and more particularly to providing digital content using artificial intelligence.

### BACKGROUND

It may be time-consuming for a user to find digital content for commercial products and services by using a user device, such as a smartphone, laptop, or tablet. To find the digital content, the user may open a search engine or a mobile application (also referred to as “app”) and manually search for products of interest. The user may then select a result from a search results page to make a purchase. The user may have to take actions at each step of this process. The user may need to know exactly what the user wants to find in order to find the digital content related to purchasing commercial products or services. Thus, the current method for finding digital content requires multiple steps and may be time-consuming.

### SUMMARY

A method embodiment may include receiving one or more user inputs; receiving current system parameters, wherein the current system parameters include at least sensor data from one or more sensors in a device and information associated with a current process running on the computing device. The method embodiment may further include determining at the device, using a machine learning model, situational context based on the current system parameters; determining at least one item of the one or more items from a local database of the device based on the situational context and the one or more user inputs; and outputting information of the at least one item.

A computing device embodiment may include: a computing device comprising: memory configured to store a machine learning model, a local database storing digital content for one or more items, and computer-executable instructions; and at least one processor configured to execute the computer-executable instructions to receive one or more user inputs; receive current system parameters, where the current system parameters include at least sensor data from one or more sensors in the computing device and information associated with a current process running on the computing device. The processor is further configured to determine, using the machine learning model, situational context based on the current system parameters; determine at least one item of the one or more items from the local database, based on the situational context and the one or more user inputs; and output, via an output interface, information of the at least one item.

A method embodiment may include: receiving one or more user inputs into a computing device; receiving system parameters comprising at least one of: sensor data from one or more sensors in the computing device and information associated with a process on the computing device; utilizing, at the computing device, a machine learning model to determine a situational context based on the received one or more user inputs and the received system parameters; and based on the determined situational context, determining, at the computing device, one or more information items stored in a local content database.

Additional method embodiments may further include: outputting information of the at least one determined information item of the one or more information items. In additional method embodiments, the output determined information item may be output in real-time. In additional method embodiments, the received one or more user inputs comprise text typed using a keyboard of the computing device. In additional method embodiments, the received one or more user inputs comprise a voice command to the computing device.

In additional method embodiments, the sensor data comprises at least one of: a time of day, a geo-location of the computing device, an orientation of the computing device, a local language used by the computing device, whether the computing device may be moving, and information available from an operating system of the computing device. In additional method embodiments, where utilizing the machine learning model to determine the situational context further comprises: receiving, by a context creator module, information from one or more sources; and generating, by the context creator module, a situational context model in response to a trigger, where the generated situational context model contains an assessment of the situational context. In additional method embodiments, the trigger may be at least one of: a scheduled process and an external event. In additional method embodiments, the received information from the one or more sources comprises one or more machine learning models and one or more manually defined heuristics and rules. In additional method embodiments, the received information from the one or more sources further comprises at least one of: sensor data from the one or more sensors, a database of historical recorded actions by a user, and a set of reference data.

Additional method embodiments may include, prior to outputting information items: calculating a conversion likelihood for the determined at least one information item of the one or more information items. In additional method embodiments, calculating the conversion likelihood further comprises: receiving, by a probability calculation module, inputs from one or more sources; and generating, by the probability calculation module, a conversion likelihood in response to a trigger, where the conversion likelihood comprises a measure of the likelihood of the user to click or act on the determined at least one information item.

In additional method embodiments, the inputs from one or more sources comprise: the generated situational context model, external historical data, user historical data, and a request from the trigger. In additional method embodiments, the external historical data comprises a dataset containing prior scenarios and outcomes from other users, and where the user historical data comprises a dataset containing prior scenarios and outcomes from the user.

Additional method embodiments may include: updating the local content database of the computing device from a global content database of a cloud computing environment via a one-way sync from the cloud computing environment to the computing device, where all user data on the computing device remains secure on the computing device and all user data on the device may be not transferred to the cloud computing environment. In additional method embodiments, updates to the local content database use delta-change sets, where the updates to the local content database comprise only additions or removals of digital content in the local content database based on a comparison of a current version of digital content contained by the local content database with digital content present in the global content database. In additional method embodiments, updating the local content database of the computing device further comprises: determining a suitable time for updating the local content database based on at least one of: a strength of a network used by the computing device to communicate with the cloud computing environment, a battery life of the computing device, and an activity on the computing device.

A computing device embodiment may include: a memory configured to store a machine learning model, a local content database configured to store digital content for one or more items, and one or more computer-executable instructions; and at least one processor in communication with the memory and configured to execute the computer-executable instructions to: receive one or more user inputs into the computing device; receive current system parameters comprising at least one of: sensor data from one or more sensors in the computing device and information associated with a process on the computing device; utilize, at the computing device, the machine learning model to determine a situational context based on the received one or more user inputs and the received system parameters; based on the determined situational context, determine, at the computing device, one or more information items stored in the local content database.

In additional computing device embodiments, the processor may be further configured to: output, via an interface, information of the at least one determined information item of the one or more information items in real-time. In additional computing device embodiments, where to determine the situational context, the processor may be further configured to: receive, by a context creator module, information from one or more sources, where the received information from one or more sources comprises at least one of: one or more machine learning models, one or more manually defined heuristics and rules, sensor data from one or more sensors, a database of historical recorded actions by a user, and a set of reference data; and generate, by the context creator module, a situational context model in response to a trigger, where the generated situational context model contains an assessment of the situational context, where the trigger may be at least one of: a scheduled process and an external event.

In additional computing device embodiments, where prior to outputting the information, the processor may be further configured to: receive, by a probability calculation module, inputs from one or more sources, where the inputs from one or more sources comprise: the generated situational context model, external historical data, user historical data, and a request from the trigger, where the external historical data comprises a dataset containing prior scenarios and outcomes from other users, and where the user historical data comprises a dataset containing prior scenarios and outcomes from the user; and generate, by a probability calculation module, a conversion likelihood in response to a trigger, where the conversion likelihood comprises a measure of the likelihood of the user to click or act on the determined at least one item.

In additional computing device embodiments, where to determine the one or more information items from the local content database, the processor may be further configured to: determine, using the machine learning model, a conversion likelihood probability of the situational context; compare the conversion likelihood probability of the situational context with a threshold; determine at least one item associated with the current situational content, when the conversion likelihood probability of the situational context may be more than the threshold; and output, via the output interface, information of the at least one information item associated with the situational context in real-time.

### BRIEF DESCRIPTION OF THE DRAWINGS

The components in the figures are not necessarily to scale, emphasis instead being placed upon illustrating the principals of the invention. Like reference numerals designate corresponding parts throughout the different views. Embodiments are illustrated by way of example and not limitation in the figures of the accompanying drawings, in which:

FIG. 1 depicts a block diagram of a system, according to one embodiment.

FIG. 2 depicts a block diagram of a workflow of the system depicted in FIG. 1, for providing digital content of one or more information items, according to one embodiment.

FIG. 3 depicts a block diagram of a workflow for creating a situational context model, according to one embodiment.

FIG. 4 depicts a block diagram of a workflow for determining a conversion likelihood, according to one embodiment.

FIG. 5 is a flow chart of a method for outputting digital content, according to one embodiment.

FIG. 6 depicts a block diagram and a process for a synchronization mechanism between a global offer database and a local offer database, according to one embodiment.

FIG. 7A depicts an exemplary graphical user interface (GUI) of the computing device, for suggesting digital contents for one or more information items based on text typed in a browser, according to one embodiment.

FIG. 7B depicts another exemplary graphical user interface (GUI) of the computing device, for suggesting digital contents for one or more information items in real-time, according to one embodiment.

FIG. 8 depicts a block diagram of a workflow of the computing device depicted in FIG. 2, for delivering rewards associated with one or more information items, according to one embodiment.

FIG. 9A depicts an exemplary graphical user interface (GUI) of the computing device, for suggesting rewards associated with one or more information items, based on text typed in a browser, according to one embodiment.

FIG. 9B depicts an exemplary GUI of the computing device for providing at least one reward associated with purchase of at least one item, according to one embodiment.

FIG. 10 is a high-level block diagram showing a computing system comprising a computer system useful for implementing an embodiment of the system and process, according to one embodiment.

FIG. 11 shows a block diagram of an example system in which an embodiment may be implemented.

FIG. 12 depicts an illustrative cloud computing environment, according to one embodiment.

### DETAILED DESCRIPTION

The following description is made for the purpose of illustrating the general principles of the embodiments discloses herein and is not meant to limit the concepts disclosed herein. Further, particular features described herein can be used in combination with other described features in each of the various possible combinations and permutations. Unless otherwise specifically defined herein, all terms are to be given their broadest possible interpretation including meanings implied from the description as well as meanings understood by those skilled in the art and/or as defined in dictionaries, treatises, etc.

The described technology concerns one or more methods, apparatuses, and mediums storing processor-executable process steps for suggesting digital contents for commercial products and services based on user inputs.

The techniques introduced below may be implemented by programmable circuitry programmed or configured by software and/or firmware, or entirely by special-purpose circuitry, or in a combination of such forms. Such special-purpose circuitry (if any) can be in the form of, for example, one or more application-specific integrated circuits (ASICs), programmable logic devices (PLDs), field-programmable gate arrays (FPGAs), etc.

The disclosed systems and methods herein enable users to find the digital content for items desired by the user on their user device, more efficiently as compared to existing searching methods and systems, and without compromising the privacy of the user data. The present system and method disclosed herein provides solutions to efficiently suggest user-relevant digital content for the items such as desired commercial products and services to the user on the user device based on user inputs. The user may purchase one or more items using an application installed on the user's device. The application may suggest at least one item with the help of one or more machine learning models stored on a remote or centralized server. By using a one-way push to the user's device, the user's privacy is not compromised while effective and efficient digital content may be presented to the user on the user's device.

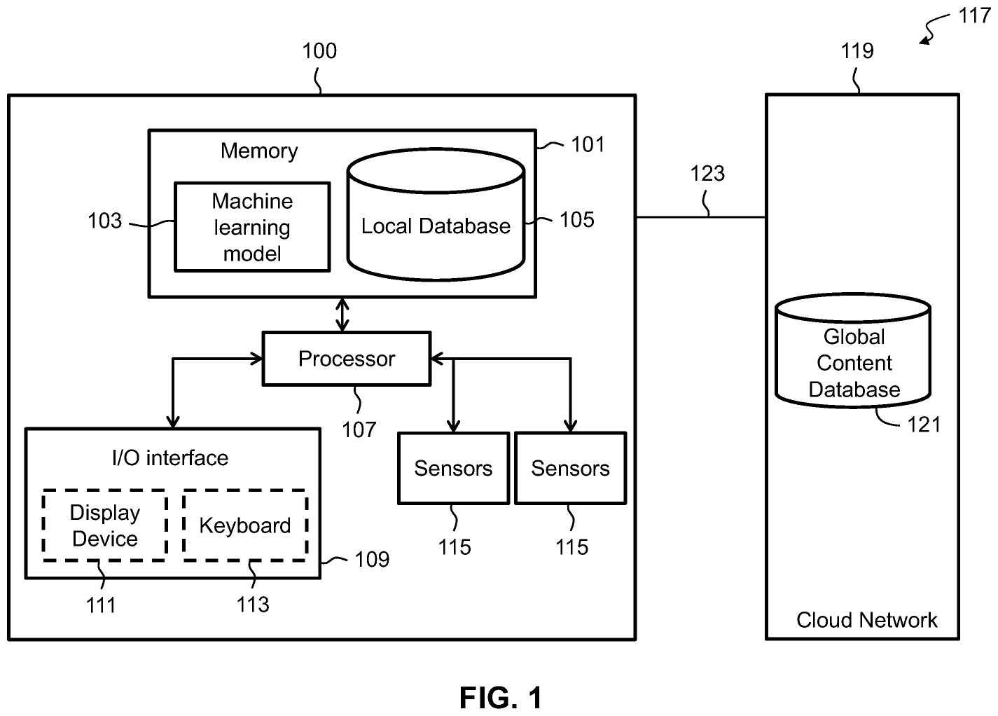

FIGS. 1-12 and the following discussion provide a brief, general description of a suitable computing environment in which aspects of the described technology may be implemented. Although not required, aspects of the technology may be described herein in the general context of computer-executable instructions, such as routines executed by a general- or special-purpose data processing device (e.g., a server or client computer). Aspects of the technology described herein may be stored or distributed on tangible computer-readable media, including magnetically or optically readable computer discs, hard-wired or preprogrammed chips (e.g., EEPROM semiconductor chips), nanotechnology memory, biological memory, or other data storage media. Alternatively, computer-implemented instructions, data structures, screen displays, and other data related to the technology may be distributed over the Internet or other networks (including wireless networks) on a propagated signal on a propagation medium (e.g., an electromagnetic wave, a sound wave, etc.) over a period. In some implementations, the data may be provided on any analog or digital network (e.g., packet-switched, circuit-switched, or other schemes).

The described technology may also be practiced in distributed computing environments where tasks or modules are performed by remote processing devices, which are linked through a communications network, such as a Local Area Network (“LAN”), Wide Area Network (“WAN”), or the Internet. In a distributed computing environment, program modules or subroutines may be located in both local and remote memory storage devices. Those skilled in the relevant art will recognize that portions of the described technology may reside on a server computer, while corresponding portions may reside on a client computer (e.g., PC, mobile computer, tablet, or smartphone). Data structures and transmission of data particular to aspects of the technology are also encompassed within the described technology scope.

Generally, to purchase items such as commercial products and/or services, a user may have to search for digital content in browsers and/or applications, e.g., merchant-specific applications, on a user device. The user device may include a smartphone, a tablet, a laptop, a computer, or the like. The digital content may include links to a point-of-sale website from where the user may purchase suggested commercial products and services; a list of nearby shops that are selling at least one commercial product of suggested commercial products; providing at least one service of suggested services; providing commercial suggestions such as a brand, products, offers or rewards; and the like.

To purchase an item, the user may have to open a browser application on the user device, navigate to a search engine to search for items such as a desired commercial product or the service, and go through the search results to select a suitable point-of-sale result to purchase the desired commercial product or service. Similarly, the user may search for the items in a merchant-specific application. Thus, finding the right digital content for the items to purchase may be a very time-consuming task.

The present system and method disclosed herein provides solutions to efficiently suggest user-relevant digital content for the items such as the commercial products and the services to the user on the user device based on user inputs. The user may be directed to a point-of-sale webpage directly with just one click on a suggested user-relevant digital content. Further, user-relevant digital content may be suggested to the user using machine learning without compromising user data privacy. To that end, mobile edge computing may be used to decentralize the machine learning model from an external server and implement a machine learning model at the user device. Further, the user device may be configured to store a local database, where the local database may store numerous digital content. Based on the user inputs and other data associated with the user device and the user, the machine learning model may select the user's relevant digital content from the local database.

FIG. 1 depicts a block diagram of a system 117 including a computing device 100 and a cloud computing environment 119, according to one embodiment. In some embodiments, the computing device 100 may be a mobile phone, a mobile device, a laptop, a tablet, a smartwatch, an augmented reality (AR) device, a virtual reality (VR) device, a wearable computing device, a smart watch, intelligent earphones, a head-mounted display (HMD), and the like. The computing device 100 may include memory 101 configured to store a machine learning model 103. The machine learning model 103 may be configured to implement one or more technologies related to artificial intelligence algorithms and deep learning. The machine learning model 103 may comprise one or more neural networks, where each neural network may be trained individually. Additionally, the memory 101 may also store a local database 105, and computer-executable instructions (not shown). The local database 105 may store data such as data associated with one or more digital content associated with one or more commercial products, services, and/or offers. The local database 105 may obtain the data associated with the one or more digital content from a remote server without sharing any information about the user with the remote server. The digital content may include links to a point-of-sale website from where the user may purchase suggested commercial products and services; a list of nearby shops that are selling at least one commercial product of suggested commercial products; providing at least one service of suggested services; providing commercial suggestions such as a brand, products, offers or rewards; and the like. The local database 105 may be scheduled to update its database periodically. Further, the computing device 100 may include a processor 107 and an input/output (I/O) interface 109. In some embodiments, the I/O interface 109 may include a display device 111 and a keyboard 113. In some embodiments, the keyboard 113 may be displayed on the display device 111 and accessible to the user through touch. Other I/O interfaces 109 are possible and contemplated. The computing device 100 may further include one or more sensors 115. The one or more sensors 115 may include a camera, a timer, a gyroscope, an accelerometer, a global positioning sensor (GPS), a barometer, a magnetometer, a microphone, an ambient light sensor, a proximity sensor, and the like. The one or more sensors 115 may be embodied as physical sensors and/or software modules. The one or more sensors 115 may be configured to provide sensor data to the processor 107, where the sensor data may include information associated with at least one of: a time of day, a geo-location of the computing device 100, an orientation of the computing device 100, a local language used by the computing device 100, whether the computing device 100 is moving, and information available from an operating system of the computing device 100. Additional sensor data is possible and contemplated based on the available sensors 115 of the computing device 100. The cloud computing environment 119 may be a cloud server, remote server, local server, or the like. The cloud computing environment 119 may communicate with the computing device via a communication protocol 123. The communication protocol 123 may be via the Internet, WiFi, cellular, and.or other communication protocols. The communication protocol 123 may be one-way from the cloud computing environment 119 to the computing device 100 such that no user data on the computing device 100 is sent to the cloud computing environment 119. The cloud computing environment 119 may contain a global content database 121. The global content database 121 may contain digital content that is synced to the local database 105 such that one or more information items may be presented to a user of the computing device 100 from the local database 105.

The computing device 100 may be configured to determine user-relevant digital content for one or more information items, from the local database 105, and suggest at least one information item of the one or more information items to the user. To that end, the computing device 100 may use the processor 107 configured to receive one or more user inputs into the computing device 100. In one embodiment, the one or more user inputs may include text typed using the keyboard 113, a voice command, or the like. Further, the processor 107 may receive system parameters associated with the computing device 100. The system parameters may be received by the processor 107 on receiving the user inputs. The system parameters may include current sensor data collected from the one or more sensors 115, recent sensor data collected from the one or more sensors 115, and/or historical sensor data collected from the one or more sensors 115. System parameters may be current, real-time, near real-time, and/or historical. System parameters may include information associated with a process running on the computing device 100, such as a type of application currently running on the computing device 100 or a type of application currently used by the user to provide the one or more user inputs. In some embodiments, the process running on the computing device 100 may be a software application, a widget, a sub-process, an operating system process, or the like. To that end, a built-in lookup table may be used to determine the type of application. Example applications on the computing device 100 may include WhatsApp™, Facebook™, messaging applications, Google Chrome™, Firefox™, browser applications, and the like. The lookup table may include a mapping between application identifiers and application types. The lookup table may be generated programmatically. In some embodiments, the lookup table may be generated by at least one of: using data obtained from application catalogs, manually, and a combination thereof.

In some embodiments, based on permissions provided by the user to obtain information from different applications running on the computing device 100, the system parameters may further include information obtained from conversations on different messaging applications, or browsing history from various browser applications, or the like.

Further, based on the system parameters, the processor 107 may be configured to determine a situational context. The situational context may be current, real-time, near-real time, or historic in some embodiments. To determine the situational context, the processor 107 may use the machine learning model 103. The machine learning model 103 may categorize the one or more user inputs into one or more categories. For example, the user's text may be categorized into one or more categories using a Long Short-Term Memory (LSTM) categorized natural language processing (NLP) model. The machine learning model 103 may be trained on a large corpus of data of sentence fragments matched to the one or more categories. In an example embodiment, one or more categories corresponding to the one or more user inputs may comprise ‘leisure,’ ‘sports,’ ‘shopping,’ ‘groceries.’ The one or more categories may be stored in the local database 105.

In some embodiments, the available recent browsing history of the user is mapped to brand categories by reference to the local database 105, e.g., looking up wayfair.com and finding the categories ‘furniture’, ‘appliances’, ‘kitchen’, and the like. The local database 105 may be configured to store major brands and applicable categories. Further, likelihood probabilities that the one or more user inputs may be associated with the one or more categories may be determined and stored in a likelihood probability array. The likelihood probability array may then be convolved with raw quantized system properties to produce the situational context.

The processor 107, based on the situational context, may determine at least one item of the one or more information items from the local database 105 that is relevant to the user and is associated with the one or more user inputs. Further, information associated with the at least one item may be provided to the user as a suggestion. The information associated with the at least one item may comprise digital content for one or more commercial products and services desired by the user. The information may be displayed on the display device 111. The information may be displayed as suggestions in real-time, i.e., while the user is providing the user input. For example, if the user is typing a text using the keyboard 113, then based on the inputted text information, one or more information items of digital content may be provided to the user on the display device 111.

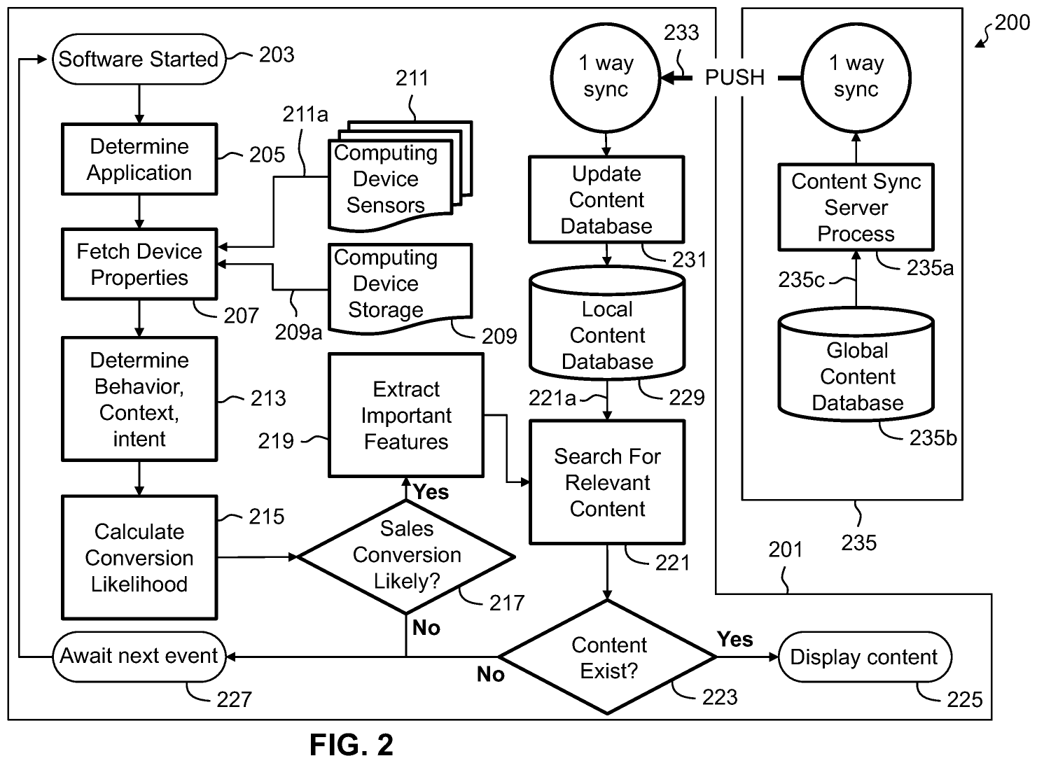

FIG. 2 depicts a block diagram of a workflow 200 of a computing device process 201 and a cloud computing environment process 235 for providing digital content associated with one or more information items, according to one embodiment. The workflow 200 may be a process. The computing device process 201 steps may be executed by the computing device (100, FIG. 1). The cloud computing environment process 235 may be executed by the cloud computing environment (119, FIG. 1). FIG. 2 is explained in conjunction with FIG. 1. The computing device process 201 may correspond to devices such as smartphones, tablets, smartwatches, or the like. The computing device process 201 may determine user-relevant digital content for one or more information items, such as commercial products and services, and suggest one or more information items of the one or more information items to the user based on input received from the user. To achieve that, a software, or application, configured to obtain a user input may be started (step 203). For example, the user may start a keyboard application (e.g., keyboard 113 of FIG. 1) to provide the user inputs by typing a text to specify an item for a function. The user may use the keyboard (113, FIG. 1) in different applications such as messaging applications to chat with another user, in a browser application to search items, in an application store to search applications for the computing device (100, FIG. 1), or the like.

An application in which the software, e.g., keyboard, is used may be determined (step 205). For example, if the user is chatting with another user on Telegram™, it is determined that the keyboard (113, FIG. 1) is being used in the messaging application. The computing device (100, FIG. 1) may use a built-in look-up table to determine the type of application currently used for accessing the keyboard (113, FIG. 1).

System parameters associated with the computing device (100, FIG. 1) may be received or fetched (step 207). The system parameters may include information 209a about device properties such as available storage space 209 and may further comprise information 211a obtained from various computing device sensors 211. The computing device sensors 211 correspond to sensors (115, FIG. 1). For example, if the computing device (100, FIG. 1) corresponds to a smartphone, the information obtained from various smartphone sensors may include information such as time of day, geo-location, the orientation of the phone, phone locale and language, whether the phone is moving, and information available from the operating system of the device.

Based on the received system parameters, situational context may be determined (step 213). The situational context may comprise information such as the behavioral context of the user, information associated with the surrounding of the user, intentions of the user, and the like. The situational context may be determined using the machine learning model (103, FIG. 1), where the machine learning model (103, FIG. 1) may be trained on historical system parameters of the computing device (100, FIG. 1).

Based on the situational context, digital content for one or more information items from the one or more information items may be determined. The digital content for one or more information items may be determined based on the situational context. The situational context may include information about products and/or services liked by the user. Thus, the determined digital content may be greatly relevant to the user.

For example, a user may be looking for directions on the computing device (100, FIG. 1). In this case, the situational context may include information associated with a current location of the user; potential destination that the user wants to reach; the current time of the day, e.g., whether it is early morning or late night; and the like. Based on the situational context about the location that the user probably wants to travel to, digital content associated with cab services or offers on cab services may be determined from a local content database 229, where the local content database 229 may be stored inside the computing device (100, FIG. 1). For example, the digital content may comprise information associated with the availability of cabs near the user, one or more applications that provide cab services, links to book a cab using the one or more applications, and the like. Further, to suggest at least one of the determined digital contents to the user on the computing device (100, FIG. 1), historical data associated with user actions, e.g., such as which of the one or more applications are mostly preferred by the user to book the cab, may be used.

A conversion likelihood probability of the situational context may be calculated (step 215). The conversion likelihood, or sales conversion, probability corresponds to a probability of the user purchasing one or more information items associated with the situational context. The conversion likelihood is a measure of the likelihood of the user to click or act on a recommendation, e.g., suggested one or more digital content, that is provided to the user. The conversion likelihood is calculated using the situational context and previous actions that have been performed by the user. An example of a suitable algorithm for implementing conversion likelihood is a Bayesian Contextual Bandit or a Neural Contextual Bandit algorithm. The Bayesian Contextual Bandit algorithm considers the situational context as input and learns from the historical propensity of the user for conversion on a specific item, e.g., purchasing of an item associated with a digital content.

In some embodiments, the conversion likelihood probability is calculated based on the situational context and historical situational context associated with the user, where the historical situational context of the user may be stored in the local content database 229. The local content database 229 corresponds to the local database (105, FIG. 1). The computing device (100, FIG. 1) may compare the currently determined situational context with the historical context to determine the situational context's conversion likelihood probability.

Based on the conversion likelihood probability; it may be determined whether the sales conversion is likely or not (step 217). To that end, the conversion likelihood of the situational context may be compared with a specific threshold. When the conversion likelihood probability is less than the threshold (step 217), the computing device process 201 may wait for the next event (step 227) when new user inputs are received from the software.

On the other hand, when the conversion likelihood probability of the situational context is more than the threshold, the workflow 200 proceeds to step 219.

Based on the situational context, an appropriate quantity of the text obtained from the software may be selected for analysis (step 219). For example, an appropriate quantity of the text typed by the user using the keyboard (113, FIG. 1), may be selected to be analyzed. The appropriate quantity of text may include more than one letter associated with a language or more than one typed message and may include a conversation of the user with another user in a messaging application. However, data obtained from the text may be stored in the local content database 229 for the analysis, where the data is not shared with any external server, such as a cloud computing environment (119, FIG. 1). The appropriate quantity of text may also include information from another keyboard on another device. The determination of the quantity of text to analyze will be made following a rule-based approach where the parameters have either been hand-set or determined through machine learning, depending on the situational context.

Further, based on the analysis of the available typed text, text features may be extracted from the text, including subjects, natural language features, actions, and intention. The analysis of the text may be performed by making use of both rule-based approaches and natural language processing. The text features may be determined from the text using the LSTM categorized NLP model, making use of word embedding vectors.

The determined text features may be used to search for relevant digital content for at least one item from the digital content of the one or more information items 221a stored in the local content database 229 (step 221). Thus, which digital content for commercial items to suggest is determined on the computing device (100, FIG. 1) itself, without communication with any external server. The digital content may be suggested to the user in real-time, i.e., while the text is being typed. Further, due to edge computing, the determination of the digital content is done on the user device without any latency. This is because the user device is not required to send any data to the cloud computing environment (119, FIG. 1) to obtain suggestions of the user's relevant digital content.

The local content database 229 ensures user privacy by keeping all user data on the computing device (100, FIG. 1) as part of the computing device process 201. The local content database 229 may be updated to include the latest digital content periodically. To that end, the computing device process 201 may request updates from a global content database 235b at a cloud computing environment (119, FIG. 1) via the Internet. In the request, the computing device process 201 may specify the current version of digital contents stored in the local content database 229. Accordingly, the cloud computing environment process 235 may update the local content database 229 (step 231) using delta-change sets, where the updates may contain only changes rather than the whole set of data. The changes, e.g., addition or removal of digital content, to be made in the local content database 229 may be determined based on a comparison of the current version of digital content contained by the local content database 229 with recent digital content present in the global content database 235b. Performing the update (step 231) as delta-changes reduces the bandwidth required for updating the local content database 229.

Further, the computing device process 201 may determine a suitable time for updating the local content database 229 (step 231) based on at least one of: the strength of a network used by the computing device (100, FIG. 1) to communicate with the cloud computing environment process (119, FIG. 1); battery life of the computing device (100, FIG. 1); activity on the computing device (100, FIG. 1), e.g., the update may be scheduled when the computing device (100, FIG. 1) is not used by the user such as when the computing device (100, FIG. 1) is idle; and the like.

In this way, the local content database 229 is updated, where the local content database 229 obtains (step 233) digital content associated with one or more commercial products, services, offers, or the like from the global content database 235b at the external server process 235 via the Internet. The digital content from the global content database 235b may be sent to the computing device (100, FIG. 1) via a one-way sync or push (step 233) via the content sync server process 235a to update the local content database 229 on the computing device (100, FIG. 1) with updated data 235c from the global content database 235b (step 231).

Further, the data in the local content database 229 may be synchronized to the computing device (100, FIG. 1) from a content synchronization server or sync server process 235a. Thus, the local content database 229 may include the one or more digital content for various items which may or may not be relevant to the user. However, based on the situational context obtained from the user input, user-relevant content for at least one item may be searched from the one or more digital content present in the local content database 229.

For searching the digital content for at least one item, at least one technique of wildcards technique and multi-language stemming technique may be used. The search results may be ranked according to relevance using belief propagating with Bayesian inference. The wildcards technique may be used to maximize search results in library databases. Wildcards are used in search terms to represent one or more other characters. Two of the most commonly used wildcards are asterisk “*” and question mark “?”. Further, the multi-language stemming applies morphological rules of two or more languages simultaneously instead of rules for only a single language when interpreting a search query. In linguistic morphology and information retrieval, stemming is the process of reducing inflected (or sometimes derived) words to their word stem, base, or root form—generally a written word form. The stem need not be identical to the morphological root of the word. It is usually sufficient that related words map to the same stem, even if this stem is not in itself a valid root.

The search results may comprise digital content for one or more information items that may be purchased by the user. In some embodiment, the results of the search are ranked according to relevance using a bm25/bm25+ algorithm.

In some embodiments, a second layer of the algorithm is used with the bm25/bm25+ algorithm for ranking the searched results. To that end, digital content corresponding to the one or more information items ranked using the bm25/bm25+ algorithm is provided to a secondary performance evaluation algorithm. The secondary performance evaluation algorithm may consider propensity for conversion, i.e., a probability of the user purchasing any of the ranked items, on the ranked one or more information items in the situational context, e.g., likelihood of an Uber booking in situation X, and a forecast of the conversion value, e.g., typical spend in situation X on brand Y. The secondary performance evaluation algorithm may rank the results again based on commercial significance, either by the conversion likelihood probability or relevance, depending on the specific user experience desired.

It may be determined whether the at least one user-relevant digital content exists or not (step 223). When the at least one user-relevant digital content does not exist, the workflow 200 waits for the next event (step 227), e.g., for new user inputs to be received from the software and/or application. On the other hand, when the at least one user-relevant digital content exists (step 223), then user-relevant digital content may be displayed to the user (step 225). The user-relevant digital content may be displayed using the display device (111, FIG. 1). The user may select the at least one digital content to purchase corresponding to at least one user-relevant item. Further, data associated with the digital content selected by the user to purchase the corresponding item is used by the machine learning model (103, FIG. 1) to personalize recommendations of the digital content to the user.

In an example embodiment, wearable devices such as a smart watch, intelligent earphones, a head-mounted display (HMD), and the like may be used to suggest user-relevant digital contents in at least one of: an audio format and a video format. The wearable devices may be communicatively coupled to the computing device (100, FIG. 1) using at least one of: near field communication (NFC) protocols, the Internet, and the like. In another embodiment, the wearable devices may be working independently without any communication with the computing device (100, FIG. 1). For example, the intelligent earphones may be configured to determine a situational context of a user. The situational context of the user may include information associated with the location of the user. For example, the intelligent earphones may determine that the user is located near a shopping mall. In this case, the intelligent earphones may suggest to the user, in the audio format, the latest offers on clothing brand preferred by the user or the nearest showroom of shoes of a brand preferred by the user and the likes. The wearable devices and the computing device (100, FIG. 1) may use a 5G communication standard to use edge computing to suggest user-relevant digital contents, in audio and/or visual format, to the user. The wearable devices mayor may not have an associated display to suggest user-relevant digital contents, in the manner described above.

In another embodiment, the digital contents suggested to the user are based on the at least one of: an age of the user, a gender of the user, a location of the user, one or more languages spoken by the user, likes and dislikes of the user, and the like. For example, there are three live concerts at three different locations, such as locations X, Y, and Z. Further, there are three users, such as user A, who is 25 years; an older user B; and user C, using their computing devices. The computing devices may be configured to suggest one or more digital content to the user as discussed above with respect to FIGS. 1-2. Further, the user A may be a male of age 25 years old who likes rock music, the user B may be 35 years old male who likes opera, and the user C may be 21 years old female who likes all-female bands. Further, a first live concert may be a rock music concert held at location X, a second live concert may be an opera concert held at location Y, and a third live concert may be a Korean music concert to be performed by an all-female band.

The computing devices of the users A, B, and C may determine situational contexts for corresponding users and based on the situational context may suggest digital content to the users. For example, the situational context may be associated with the locations of the users, ages of the users, and types of music liked by the users. Accordingly, the user A may be suggested with digital content associated with the first live concert, where the digital content may include offers on tickets to the concert, one or more links to book tickets, and the like. Further, the user B may be provided with digital content associated with the second live concert and the user C may be provided with digital content associated with the third live concert.

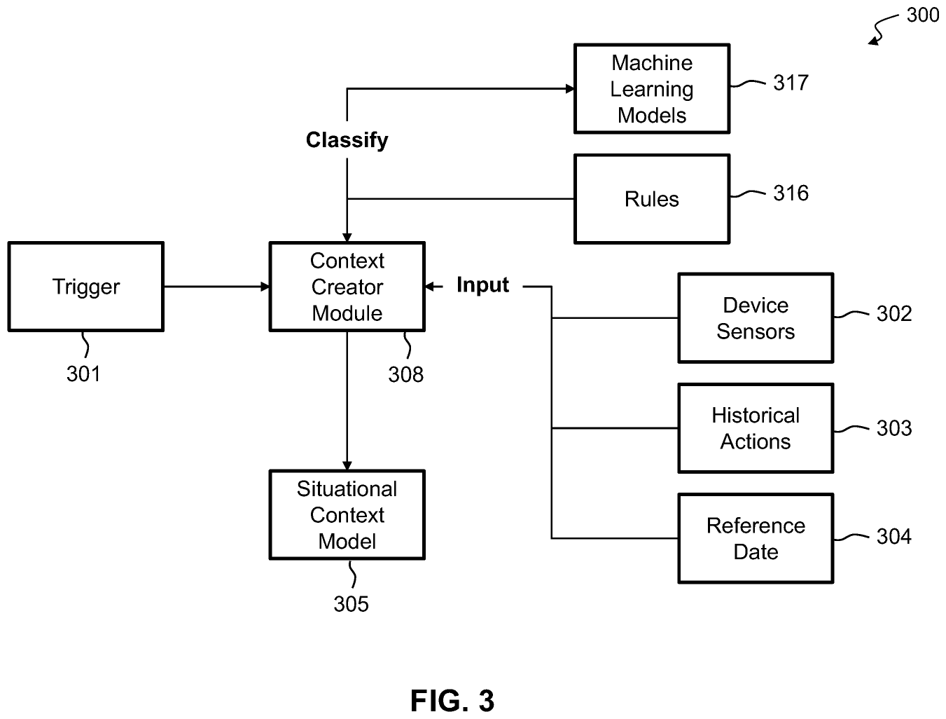

FIG. 3 depicts a block diagram of a workflow 300 for creating a situational context model, according to one embodiment. The created situational context model may be used to determine situational context that may include information such as the behavioral context of the user, information associated with the surrounding of the user, intentions of the user, and the like (step 213; FIG. 2). The workflow 300 may be triggered 301 by an external system, which may be a scheduled process or external event. The context creator module 308 may assemble information from multiple sources, including but not limited to device sensors 302, a database of historical recorded actions by the user 303, and a set of system configured reference data 304. Through the application of manually defined heuristics and rules 316 and machine learning models 317 which may be pre-built or trained in an ongoing fashion, a situational context model 305 may be created. The situational context model 305 may contain an assessment of the current situation.

In one example of the workflow 300, reference data might require that the situational context contain a property that indicates whether the user is travelling. The context creator module 308 can determine this through application of a machine learning model with input from the device sensors 302, and write the result to the situational context model 305. The context creator module 308 may be a module embodied on the processor (107, FIG. 1) of a computing device (100, FIG. 1) such as a user device.

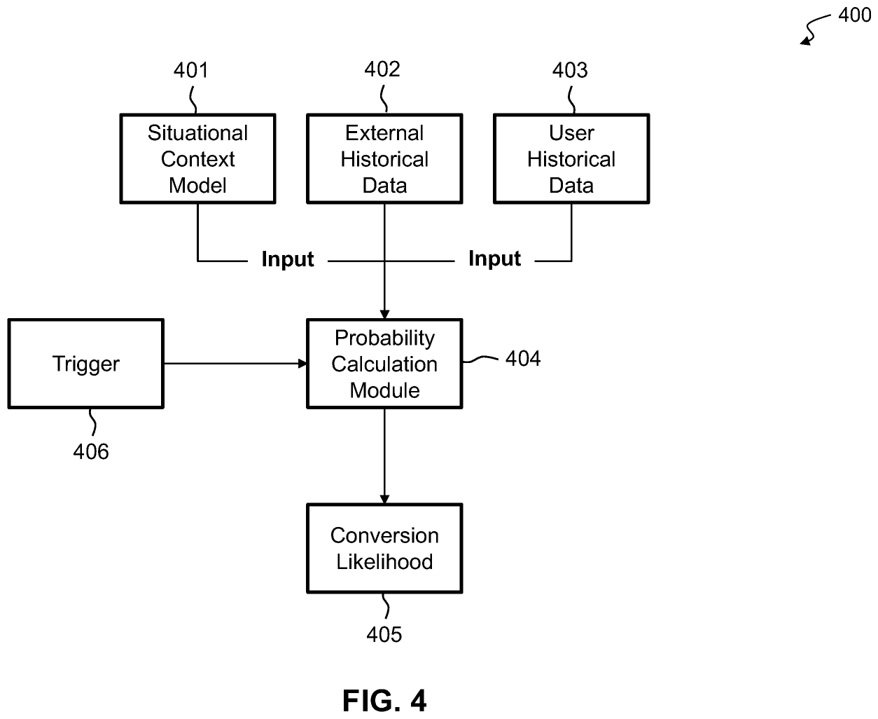

FIG. 4 depicts a block diagram of a workflow 400 for determining a conversion likelihood, according to one embodiment. The created situational context model may be used to determine a conversion likelihood, or sales conversion, probability that corresponds to a probability of the user purchasing one or more information items associated with the situational context (step 215; FIG. 2). A conversion likelihood 405 may be the likelihood that given a proposal and/or offer to the user that the user will engage with that proposal and/or offer. This workflow 400 may be triggered by a trigger 406. The trigger 406 may be a request to calculate a conversion likelihood. The probability calculation module 404 is the calculation that is performed. The probability calculation module 404 takes as an input the output from the workflow for creating a situational context model (300, FIG. 3), a situational context model 401, as well as external historical data 402, a dataset containing prior scenarios and outcomes from other users, a dataset containing prior scenarios and outcomes from this user 403, and the request from the Trigger 406 itself. The probability calculation module 404 then performs a probability calculation, which may be a Bayesian contextual bandit, to demine a probability of a conversion given the prior actions for the requested action in the trigger 406. This result is output as a conversion likelihood 405. The probability calculation module 404 may be a module embodied on the processor (107, FIG. 1) of a computing device (100, FIG. 1) such as a user device.

In one example, the situational context model 401 may contain the information that the user is travelling. External historical data 402 may show that users who are travelling have a propensity to engage with certain categories of offers such as games. User historical data 403 may show though that in previous similar scenarios the disclosed system has suggested games to the user and the user has accepted and/or engaged with this offer. When triggered by the trigger 406, the probability calculation module 404 may determine that given this information the user should be shown an offer because it has a high conversion likelihood 405.

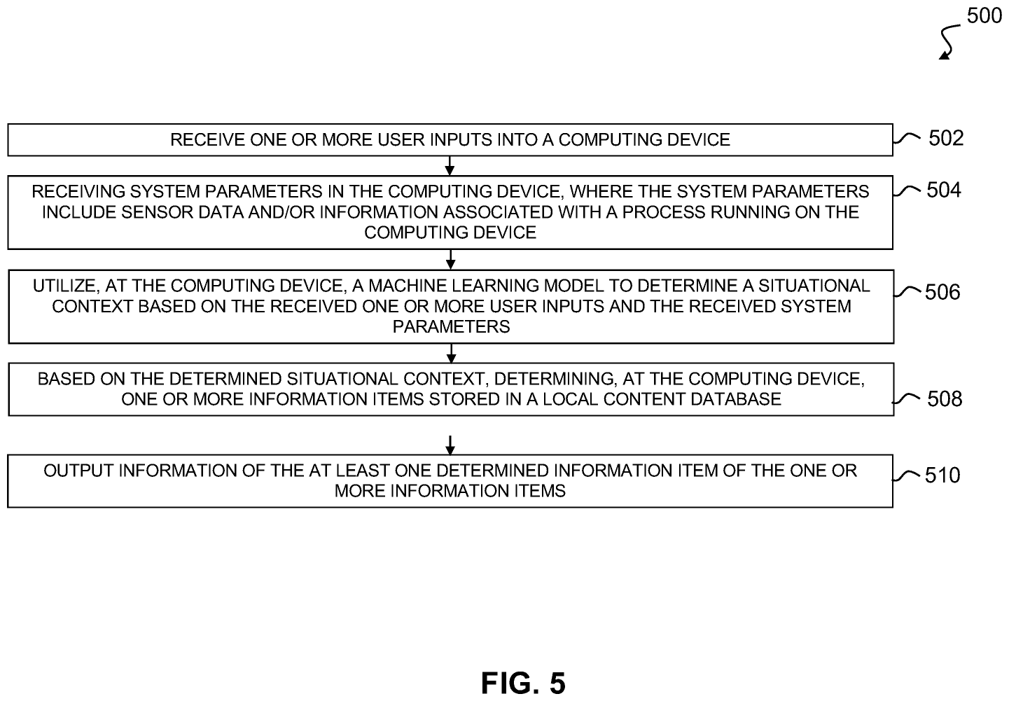

FIG. 5 is a flow chart of a method 500 for outputting digital content, according to one embodiment of the present disclosure. The method 500 may include receiving one or more user inputs into a computing device (step 502). The method 500 may then include receiving system parameters in the computing device (step 504). The system parameters may include sensor data from one or more sensors in a computing device and/or information associated with a process running on the computing device. The process running on the computing device may be a current process or a historical process. The method 500 may then include utilizing, at the computing device, a machine learning model to determine a situational context based on the received one or more user inputs and the received system parameters (step 506). The method 500 may then include based on the determined situational context, determining, at the computing device, one or more information items stored in a local content database (step 508). In some embodiments, the method 500 may then include selecting, at the computing device, at least one information item of the one or more information items from a local content database of the computing device based on the determined situational context. In some embodiments, the determined at least one information item may be based on the determined situational context and the received one or more user inputs. The method 500 may then include outputting information of at least one information item (step 510). The outputted information may be displayed on a display device (111, FIG. 1), communicated via audio, or the like.

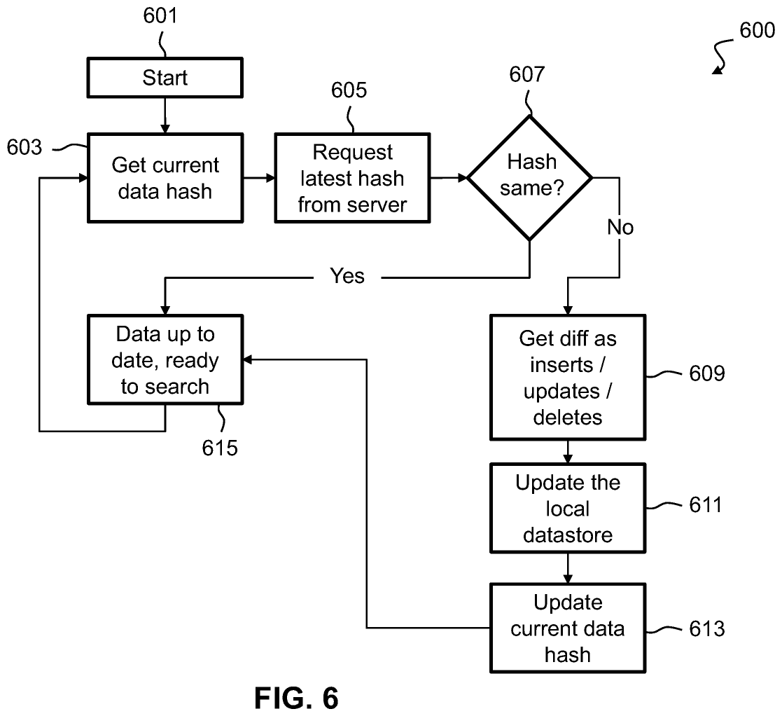

FIG. 6 depicts a synchronization mechanism of a local database (105, FIG. 1), according to one embodiment. The local database (105, FIG. 1) may be periodically updated and synchronized with the global content database (235b, FIG. 2) using the synchronization mechanism. A cloud computing environment process (235, FIG. 2) may update the local content database 229 (step 231, FIG. 2) using delta-change sets, where the updates may contain only changes rather than the whole set of data. The synchronization mechanism may use a hashing method. Hashing is the transformation of a string of characters into a usually shorter fixed-length value or key that represents the original string. Hashing is used to index and retrieve items in a database because it is faster to find the item using the shorter hashed key than to find it using the original value. The synchronization mechanism starts (step 601). A current data hash (step 603) may be obtained.

The latest hash from the server may be requested (step 605). It may be determined whether the hash name is same or not (step 607). When the hash name is same, the synchronization mechanism 600 proceeds to step 609. It may be determined that the data in the local database (105, FIG. 1) is up to date, and ready to search (step 615).

On the other hand, when the hash name is not same, the synchronization mechanism proceeds to step 609. The difference may be obtained as a set of insert/update/delete operations (step 609). The local database (105, FIG. 1) is updated based on the obtained set of insert/update/delete operations (step 611). Once the local datastore is update, the current data hash is also updated (step 613). Further, based on the updated hash, search for relevant digital content may be performed.

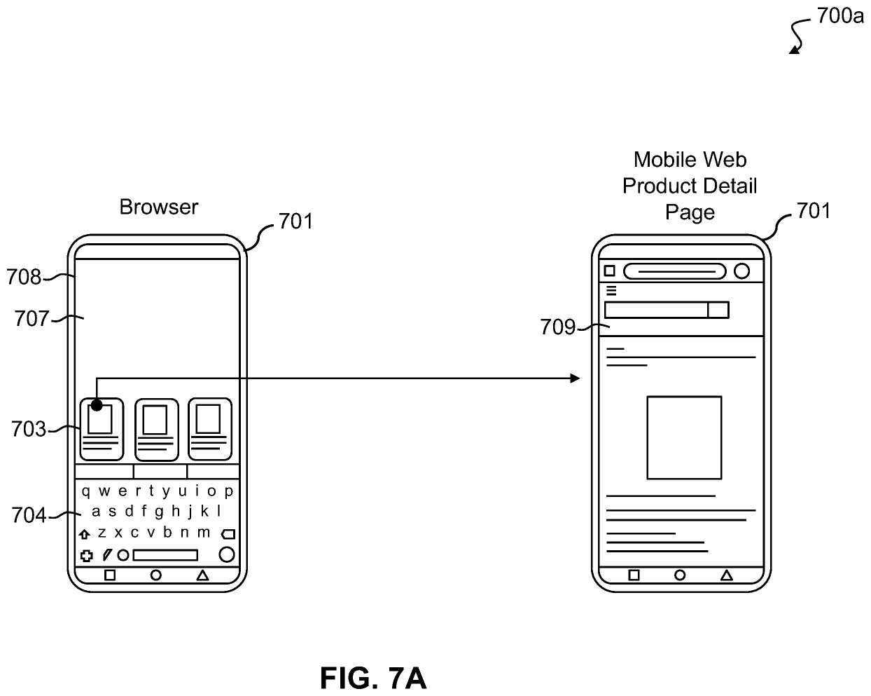

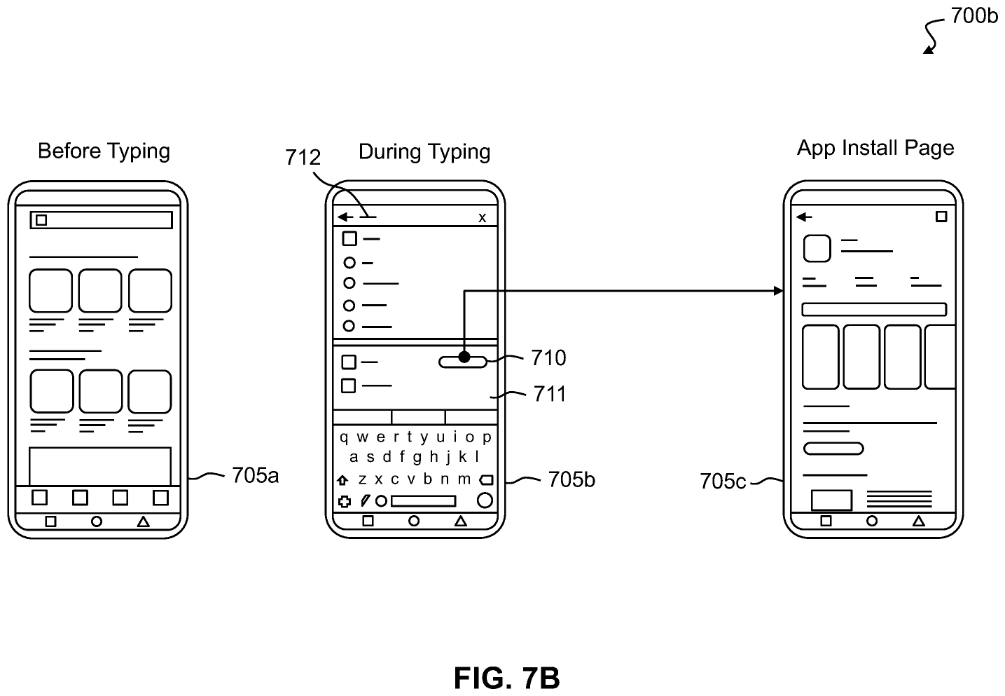

FIG. 7A depicts an exemplary GUI associated with a computing device 700a for suggesting digital content for one or more information items based on text typed in a browser, according to one embodiment. In FIG. 7A, the computing device 700a corresponds to a smartphone 701. As the user types of the text using the keyboard 704 (113, FIG. 1) in the browser window 707, the digital content associated with one or more commercial products 703 is suggested on the display device 708 (111, FIG. 1) above the keyboard 704 (113, FIG. 1). For example, the digital content may correspond to a link to a point-of-sale website such as Amazon.com™. The digital content may be displayed as product tiles above the keyboard 704 (113, FIG. 1). There may be 3-5 tiles in a row above the keyboard. Other numbers of tiles and/or arrangements of tiles is possible and contemplated. In some embodiments, the tiles may be scrolled end-to-end horizontally. In one embodiment, there may be maximum seven tiles in a row. Other maximum numbers of tiles are possible and contemplated. On clicking the tiles, the user is directly navigated to the point-of-sale website 709 to purchase product corresponding to the tile.

FIG. 7B depicts a computing device 700b suggesting digital content for one or more information items in real-time, according to one embodiment. FIG. 7B is described in conjunction with FIG. 7A. In FIG. 7B, the computing device 700b corresponds to a smartphone. In FIG. 7B, before typing 705a keywords or text in the smartphone, no digital content is suggested. During typing 705b, i.e., in real-time, one or more digital content are suggested. The suggested one or more digital contents are updated as the user keeps typing the text 712. Thus, the digital content are updated, based on the text 712 received in real-time. For example, based on the typed text 712, e.g., Uber, the user may be suggested services associated with Uber. The user may select at least one of the suggested services associated with the Uber. In case, to avail suggested services requires installation of an application, the user may be directly navigated to the installation page of the application 705c on selecting 710 the suggested service. For example, on selecting 710 at least one of the suggested services 711, the user is directly taken on the installation page 705c of the Uber application. In this way, a considerable amount of time of the user, for finding digital content associated with the one or more information items, is saved.

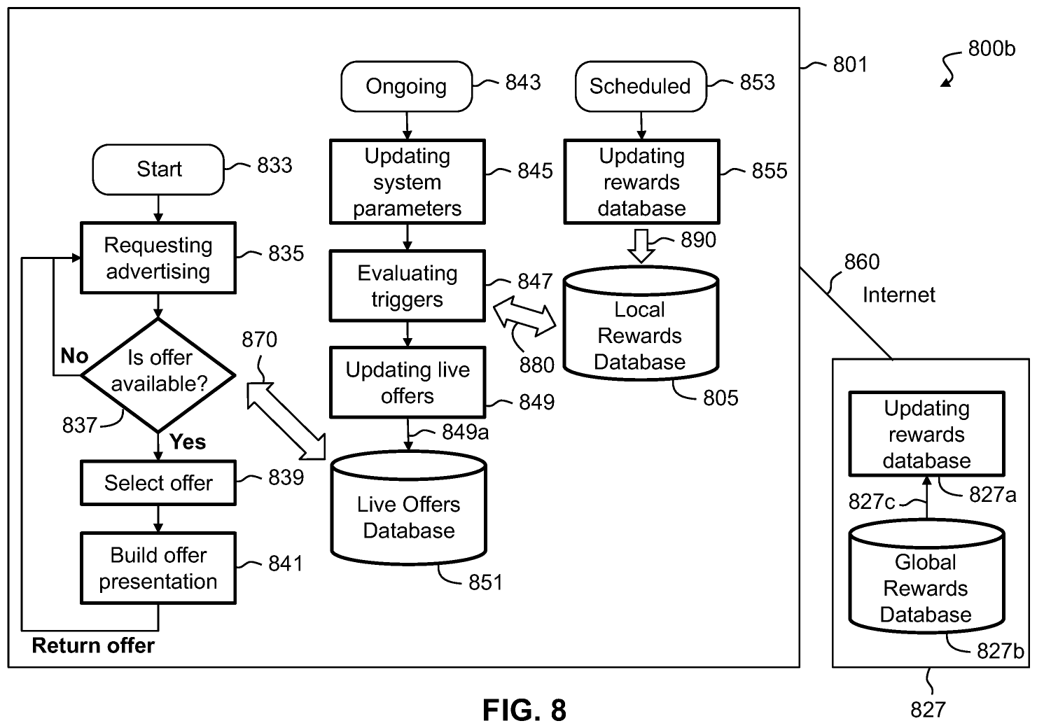

FIG. 8 depicts a block diagram of a workflow 800b of the computing device 801 depicted in FIG. 2, for delivering rewards associated with one or more information items, according to one embodiment. The computing device 801 uses edge computing on the computing device 801 for matching the received user inputs to one or more information items with rewards and suggests the matched at least one item with reward to the user on the computing device 801. Edge computing brings computation and data storage closer to devices, such as computing device 801, where it's being gathered, rather than relying on a central location that can be located far away. Edge computing ensures that data, especially real-time data, does not suffer latency issues that can affect performance of an application.

The workflow 800b starts at step 833. Advertising for reward may be requested (step 835). It may be determined whether an offer, such as in the form of one or more information items with rewards 870, is available or not (step 837). When the one or more information items with rewards are not available, the workflow 800b keeps requesting advertising (step 835).

On the other hand, when the one or more information items with rewards are available, then at least one item with a reward may be selected from the one or more information items with rewards (step 839). The at least one item with the reward may be selected from the local rewards database 805 or a live offers database 851.

Further, a reward presentation associated with the at least one item may be built (step 841), where the at least one item with the reward may be used to further request advertising (step 835). The reward presentation may include displaying offers with rewards on a keyboard (113, FIG. 1). This may be represented in the GUIs illustrated herein.

Further, live offers (i.e., rewards) may be obtained by the computing device 801, where the live offers may be obtained based on the one or more user inputs. The live offers may be updated in real-time, e.g., when the live offer is ongoing 843. To that end, ongoing offers may be determined. System parameters may be updated to reflect the latest user actions, inputs, and choices (step 845). Triggers may be evaluated (step 847) based on the items 880 in the local rewards database 805, where the triggers may be associated with the one or more user inputs. Live offers may be updated (step 849) and stored 849a in the live offers database 851. The live offers database 851 may be stored in the computing device 801 itself and may be included in local rewards database 805. Further, at least one live offer relevant to the user may be selected from the live offers database 851 and presented to the user on the display device (111, FIG. 1). Based on the live offers database 851, the local rewards database 805 may be updated.

Additionally, the local rewards database 805 may be scheduled (step 853) to be updated. At the schedule (step 853), rewards and/or offers in the local rewards database 805 may be updated (step 855). To that end, the local rewards database 805 obtains updated rewards (step 855) associated with one or more commercial products, service, offers, or the like from a global rewards database 827b at a remote server 827. In order to reduce bandwidth required for updating the local rewards database 805, the updates may be performed as delta-change sets, as described in FIG. 6. Further, the data in the local rewards database 805 may be synchronized 860 to the computing device 801 from data 827c in the global rewards database 827b via a synchronization server or sync server process 827a via the Internet, WiFi, or other communication protocol 860.

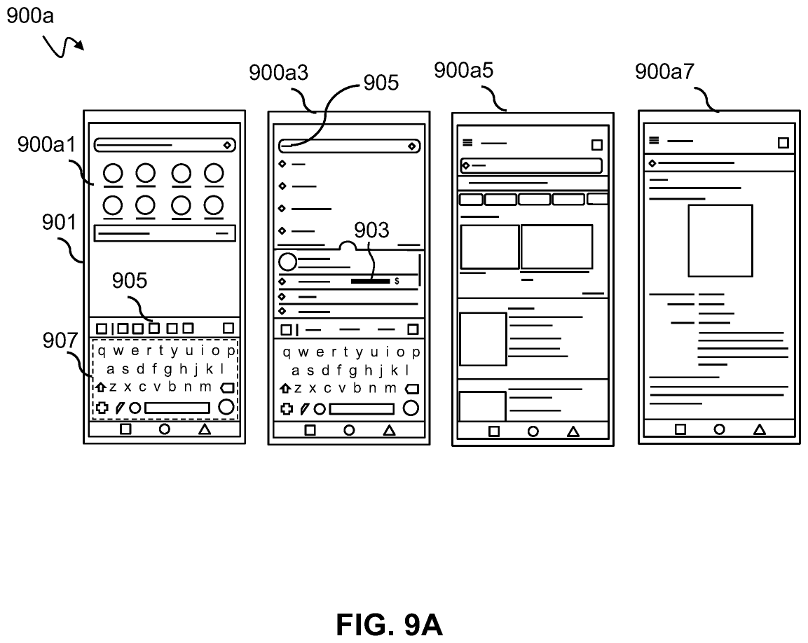

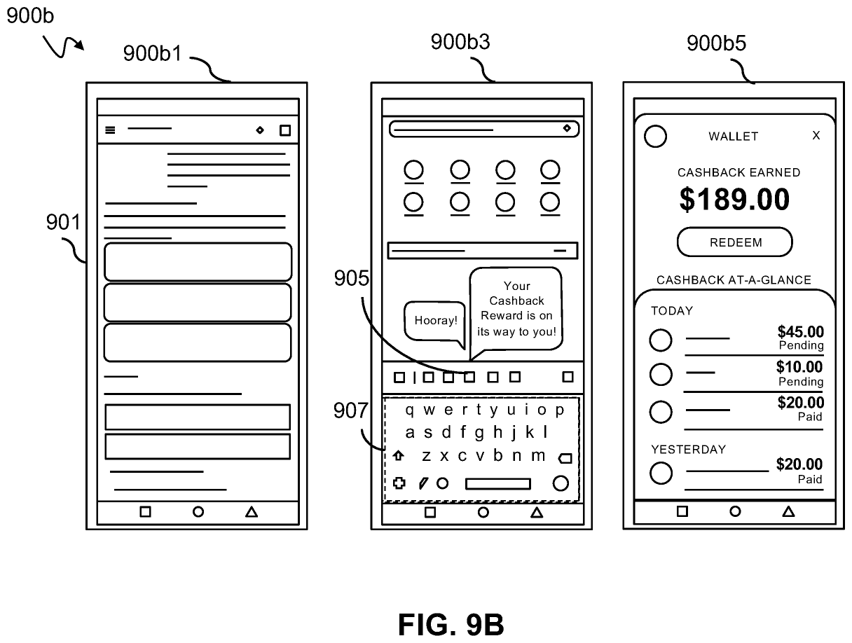

FIG. 9A depicts an exemplary graphical user interface (GUI) 900a of the computing device for suggesting rewards associated with one or more information items, based on the text typed in a browser, according to one embodiment. In FIG. 9A, the computing device corresponds to a smartphone. GUI 900al illustrates a browser window opened by the user, a keyboard 907, which will be used by the user to type text in the browser window, and a wallet 905 displayed just above the keyboard 907 (113, FIG. 1). The wallet 905 corresponds to a monetary fund account installed on the computing device of the user. Balance of the wallet may be shown directly to the user, and the wallet may be directly accessible from the keyboard 907 (113, FIG. 1).

GUI 900a3 illustrates that as the user types the text 905 using the keyboard 907 in the browser window, the rewards 903 associated with the one or more commercial products, determined by the computing device based on the typed text 905, are suggested above the keyboard 907. For example, the rewards 903 may comprise a cashback offer on the purchase of an iPad™ from a point-of-sale website such as Amazon.com™. Therefore, as soon as the user types “iPad” in the browser window, as shown in GUI 900a5, the cashback reward offered by Amazon.com™ is suggested right above the keyboard 907, where it is easy for the user to select the offer.

In an example embodiment, the rewards 903 may be displayed as a list of rewards above the keyboard 907, where the user may scroll up and down the list to determine which reward the user wants to avail. In another embodiment, the rewards may be displayed as reward tiles above the keyboard 907. There may be 3-5 tiles in a row above the keyboard 907. The tiles may be scrolled end-to-end horizontally. There may be a maximum of 7 tiles in a row. Other numbers and/or arrangements are possible and contemplated. On clicking a tile, the user is directly navigated to the point-of-sale website or page offering rewards in the selected tile, as displayed in GUI 900a7.

FIG. 9B depicts an exemplary GUI 900b of the computing device for providing at least one reward associated with the purchase of at least one item, according to one embodiment. FIG. 9B is described below in conjunction with FIG. 9A. GUI 900b1 illustrates that after clicking on the reward (903, FIG. 9A) suggested to the user in GUI (900a3, FIG. 3), the user is navigated to a point-of-sale website page (such as Amazon.com™), providing the cashback offer of 189 dollars. In GUI 900b3, on purchasing the at least one item with a reward, for example, the iPad™ with 189 dollars cashback offer from the point-of-sale website, the cashback is rewarded to the user in real-time. The rewarded cashback will be deposited in the wallet 905. The wallet 905 is immediately available during the purchasing process when the keyboard 907 is open. Further, the cashback offer is immediately launched, and on purchase, the cashback is rewarded immediately or in real-time to the user. Further, GUI 900b5 illustrates that on selecting the wallet 905, by clicking on a wallet icon above the keyboard 907, the rewards such as remunerated 189 dollars cashback and the like may be displayed on the computing device.

An embodiment disclosed herein seamlessly provides a user with the digital content (e.g., information items such as digital links related to products/services) that allow the user to purchase commercial products or services, utilizing the mobile computing device 100.

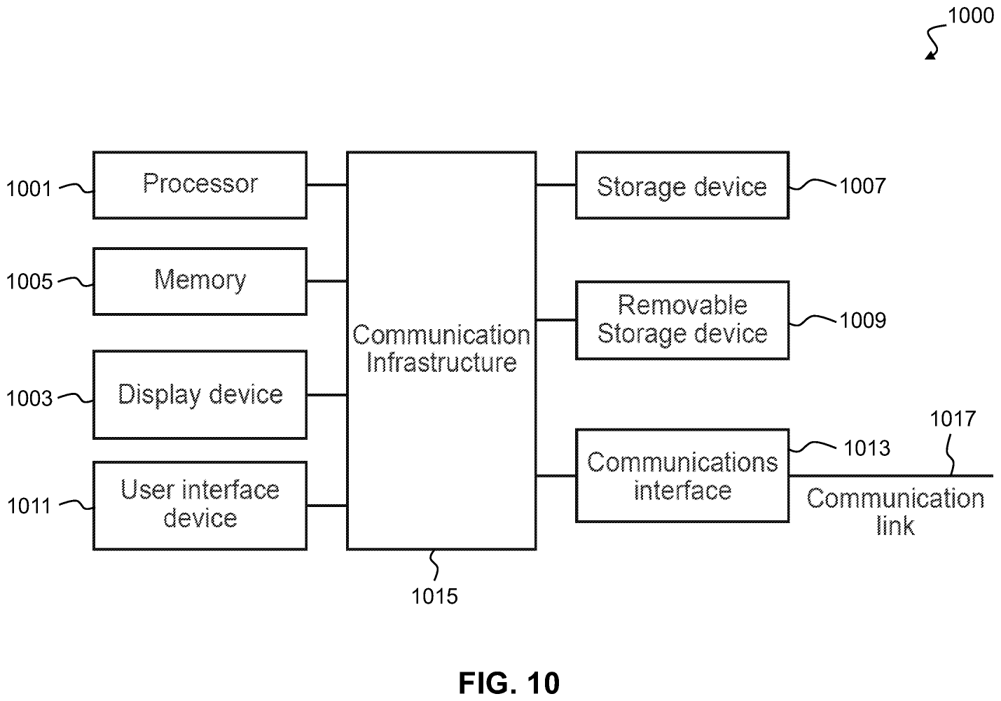

FIG. 10 is a high-level block diagram 1000 showing a computing system comprising a computer system useful for implementing an embodiment of the system and process, disclosed herein. Embodiments of the system may be implemented in different computing environments. The computer system includes one or more processors 1001, and can further include an electronic display device 1003 (e.g., for displaying graphics, text, and other data), a main memory 1005 (e.g., random access memory (RAM)), storage device 1007, a removable storage device 1009 (e.g., removable storage drive, a removable memory module, a magnetic tape drive, an optical disk drive, a computer-readable medium having stored therein computer software and/or data), user interface device 1011 (e.g., keyboard, touch screen, keypad, pointing device), and a communication interface 1013 (e.g., modem, a network interface (such as an Ethernet card), a communications port, or a PCMCIA slot and card). The communication interface 1013 allows software and data to be transferred between the computer system and external devices. The system further includes a communications infrastructure 1015 (e.g., a communications bus, cross-over bar, or network) to which the aforementioned devices/modules are connected as shown.

Information transferred via communications interface 1015 may be in the form of signals such as electronic, electromagnetic, optical, or other signals capable of being received by communications interface 1015, via a communication link 1017 that carries signals and may be implemented using wire or cable, fiber optics, a phone line, a cellular/mobile phone link, a radio frequency (RF) link, and/or other communication channels. Computer program instructions representing the block diagram and/or flowcharts herein may be loaded onto a computer, programmable data processing apparatus, or processing devices to cause a series of operations performed thereon to produce a computer implemented process.

Embodiments have been described with reference to flowchart illustrations and/or block diagrams of methods, apparatus (systems) and computer program products according to embodiments. Each block of such illustrations/diagrams, or combinations thereof, can be implemented by computer program instructions. The computer program instructions when provided to a processor produce a machine, such that the instructions, which execute via the processor, create means for implementing the functions/operations specified in the flowchart and/or block diagram. Each block in the flowchart/block diagrams may represent a hardware and/or software module or logic, implementing embodiments. In alternative implementations, the functions noted in the blocks may occur out of the order noted in the figures, concurrently, etc.

Computer programs (i.e., computer control logic) are stored in main memory and/or secondary memory. Computer programs may also be received via a communications interface 1013. Such computer programs, when executed, enable the computer system to perform the features of the embodiments as discussed herein. In particular, the computer programs, when executed, enable the processor and/or multi-core processor to perform the features of the computer system. Such computer programs represent controllers of the computer system.

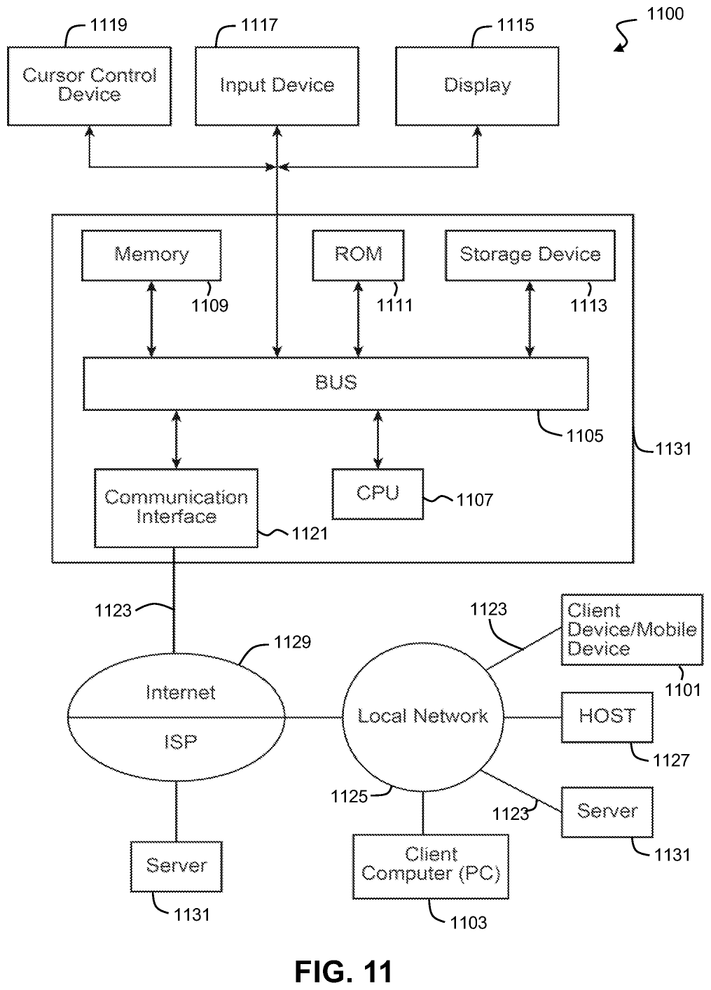

FIG. 11 shows a block diagram of an example system 1100 in which an embodiment may be implemented. The system 1100 includes one or more client devices 1101 such as consumer electronics devices, connected to one or more server computing systems 1131. A server 1131 includes a bus 1105 or other communication mechanism for communicating information, and a processor (CPU) 1107 coupled with the bus 1105 for processing information. The server 1131 also includes a main memory 1109, such as a random-access memory (RAM) or other dynamic storage device, coupled to the bus 1105 for storing information and instructions to be executed by the processor 1107. The main memory 1109 also may be used for storing temporary variables or other intermediate information during execution or instructions to be executed by the processor 1107. The server computer system 1131 further includes a read only memory (ROM) 1111 or other static storage device coupled to the bus 1105 for storing static information and instructions for the processor 1107. A storage device 1113, such as a magnetic disk or optical disk, is provided and coupled to the bus 1105 for storing information and instructions. The bus 1105 may contain, for example, thirty-two address lines for addressing video memory or main memory 1109. The bus 1105 can also include, for example, a 32-bit data bus for transferring data between and among the components, such as the CPU 1107, the main memory 1109, video memory and the storage 1113. Alternatively, multiplex data/address lines may be used instead of separate data and address lines.

The server 1131 may be coupled via the bus 1105 to a display 1115 for displaying information to a computer user. An input device 1117, including alphanumeric and other keys, is coupled to the bus 1105 for communicating information and command selections to the processor 1107. Another type or user input device comprises cursor control 1119, such as a mouse, a trackball, or cursor direction keys for communicating direction information and command selections to the processor 1107 and for controlling cursor movement on the display 1115.

According to one embodiment, the functions are performed by the processor 1107 executing one or more sequences of one or more instructions contained in the main memory 1109. Such instructions may be read into the main memory 1109 from another computer-readable medium, such as the storage device 1113. Execution of the sequences of instructions contained in the main memory 1109 causes the processor 1107 to perform the process steps described herein. One or more processors in a multi-processing arrangement may also be employed to execute the sequences of instructions contained in the main memory 1109. In alternative embodiments, hard-wired circuitry may be used in place of or in combination with software instructions to implement the embodiments. Thus, embodiments are not limited to any specific combination of hardware circuitry and software.

The terms “computer program medium,” “computer usable medium,” “computer readable medium”, and “computer program product,” are used to generally refer to media such as main memory, secondary memory, removable storage drive, a hard disk installed in hard disk drive, and signals. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Furthermore, the computer readable medium may comprise computer readable information in a transitory state medium such as a network link and/or a network interface, including a wired network or a wireless network that allow a computer to read such computer readable information. Computer programs (also called computer control logic) are stored in main memory and/or secondary memory. Computer programs may also be received via a communications interface. Such computer programs, when executed, enable the computer system to perform the features of the embodiments as discussed herein. In particular, the computer programs, when executed, enable the processor multi-core processor to perform the features of the computer system. Accordingly, such computer programs represent controllers of the computer system.

Generally, the term “computer-readable medium” as used herein refers to any medium that participated in providing instructions to the processor 1107 for execution. Such a medium may take many forms, including but not limited to, non-volatile media, volatile media, and transmission media. Non-volatile media includes, for example, optical or magnetic disks, such as the storage device 1113. Volatile media includes dynamic memory, such as the main memory 1109. Transmission media includes coaxial cables, copper wire and fiber optics, including the wires that comprise the bus 1105. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, an EPROM, a FLASH-EPROM, any other memory chip or cartridge, a carrier wave as described hereinafter, or any other medium from which a computer can read.

Various forms of computer readable media may be involved in carrying one or more sequences of one or more instructions to the processor 1107 for execution. For example, the instructions may initially be carried on a magnetic disk of a remote computer. The remote computer can load the instructions into its dynamic memory and send the instructions over a telephone line using a modem. A modem local to the server 1131 can receive the data on the telephone line and use an infrared transmitter to convert the data to an infrared signal. An infrared detector coupled to the bus 1105 can receive the data carried in the infrared signal and place the data on the bus 1105. The bus 1105 carries the data to the main memory 1109, from which the processor 1107 retrieves and executes the instructions. The instructions received from the main memory 1109 may optionally be stored on the storage device 1113 either before or after execution by the processor 1107.

The server 1131 also includes a communication interface 1121 coupled to the bus 1105. The communication interface 1121 provides a two-way data communication coupling to a network link 1123 that is connected to the worldwide packet data communication network now commonly referred to as the Internet 1129. The Internet 1129 uses electrical, electromagnetic or optical signals that carry digital data streams. The signals through the various networks and the signals on the network link 1123 and through the communication interface 1121, which carry the digital data to and from the server 1131, are exemplary forms or carrier waves transporting the information.

In another embodiment of the server 1131, interface 1121 is connected to a network 1125 via the network/communication link 1123. For example, the communication interface 1121 may be an integrated services digital network (ISDN) card or a modem to provide a data communication connection to a corresponding type of telephone line, which can comprise part of the network link 1123. As another example, the communication interface 1121 may be a local area network (LAN) card to provide a data communication connection to a compatible LAN. Wireless links may also be implemented. In any such implementation, the communication interface 1121 sends and receives electrical electromagnetic or optical signals that carry digital data streams representing various types of information.

The network link 1123 typically provides data communication through one or more networks to other data devices. For example, the network link 1123 may provide a connection through the local network 1125 to a host computer 1127 or to data equipment operated by an Internet Service Provider (ISP). The ISP in turn provides data communication services through the Internet 1129. The local network 1125 and the Internet 1129 both use electrical, electromagnetic or optical signals that carry digital data streams. The signals through the various networks and the signals on the network link 1123 and through the communication interface 1121, which carry the digital data to and from the server 1131, are exemplary forms or carrier waves transporting the information.

The server 1131 can send/receive messages and data, including e-mail, program code, through the network, the network link 1123 and the communication interface 1121. Further, the communication interface 1121 can comprise a USB/Tuner and the network link 1123 may be an antenna or cable for connecting the server 1131 to a cable provider, satellite provider or other terrestrial transmission system for receiving messages, data and program code from another source.

The example versions of the embodiments described herein may be implemented as logical operations in a distributed processing system such as the system 1100 including the servers 1131. The logical operations of the embodiments may be implemented as a sequence of steps executing in the server 1131, and as interconnected machine modules within the system 1100. The implementation is a matter of choice and can depend on performance of the system 1100 implementing the embodiments. As such, the logical operations constituting said example versions of the embodiments are referred to for e.g., as operations, steps or modules.

Similar to a server 1131 described above, a client device 1101 can include a processor, memory, storage device, display, input device and communication interface (e.g., e-mail interface) for connecting the client device to the Internet 1129, the ISP, or LAN 1125, for communication with the servers 1131.

The system 1100 can further include computers (e.g., personal computers, computing nodes) 1103 operating in the same manner as client devices 1101, wherein a user can utilize one or more computers 1103 to manage data in the server 1131.

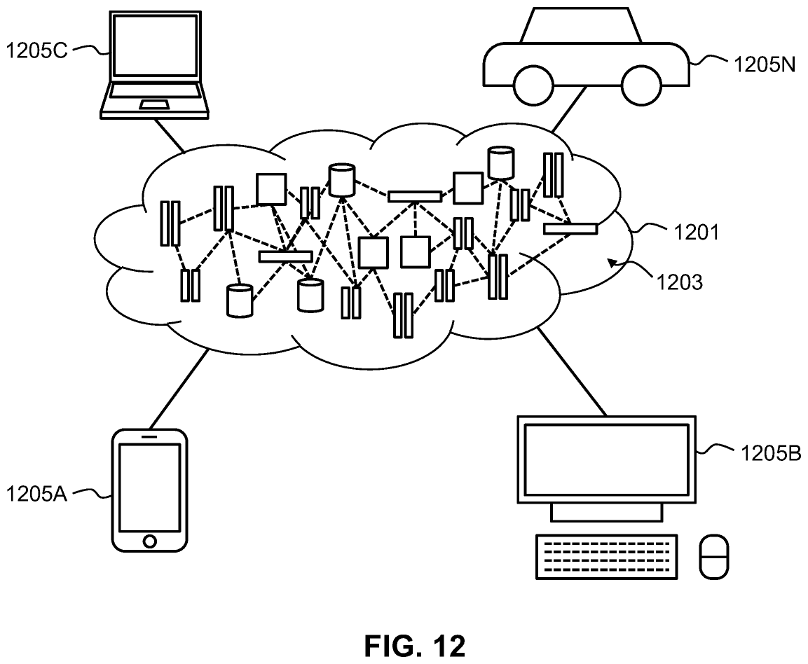

FIG. 12 depicts an illustrative cloud computing environment 1201, according to one embodiment. As shown, cloud computing environment 1201 comprises one or more cloud computing nodes 1203 with which local computing devices used by cloud consumers, such as, for example, personal digital assistant (PDA), smartphone, smart watch, set-top box, video game system, tablet, mobile computing device, or cellular telephone 1205A, desktop computer 1205B, laptop computer 1205C, and/or automobile computer system 1205N may communicate. Nodes 1203 may communicate with one another. They may be grouped (not shown) physically or virtually, in one or more networks, such as Private, Community, Public, or Hybrid clouds as described hereinabove, or a combination thereof. This allows cloud computing environment 1201 to offer infrastructure, platforms and/or software as services for which a cloud consumer does not need to maintain resources on a local computing device. It is understood that the types of computing devices 1205A-N shown in FIG. 12 are intended to be illustrative only and that computing nodes 1203 and cloud computing environment 1201 can communicate with any type of computerized device over any type of network and/or network addressable connection (e.g., using a web browser).

It is contemplated that various combinations and/or sub-combinations of the specific features and aspects of the above embodiments may be made and still fall within the scope of the invention. Accordingly, it should be understood that various features and aspects of the disclosed embodiments may be combined with or substituted for one another in order to form varying modes of the disclosed invention. Further, it is intended that the scope of the present invention herein disclosed by way of examples should not be limited by the particular disclosed embodiments described above.

1. A method, comprising:
receiving one or more user inputs into a computing device;
receiving system parameters comprising at least one of: sensor data from one or more sensors in the computing device and information associated with a process on the computing device;
utilizing, at the computing device, a machine learning model to determine a situational context based on the received one or more user inputs and the received system parameters; and
based on the determined situational context, determining, at the computing device, one or more information items stored in a local content database.

2. The method of claim 1, wherein the one or more determined information items comprise one or more of: links to a point-of-sale website for purchasing a suggested commercial product, and links to a point-of-sale website for purchasing a suggested commercial service.

3. The method of claim 1, further comprising:
outputting information of the at least one determined information item of the one or more information items.

4. The method of claim 3, wherein the output determined information item is output in real-time while receiving the one or more user inputs into the computing device, wherein the real-time output uses edge computing on the computing device.

5. The method of claim 3, wherein the computing device comprises a mobile computing device having a display and a virtual keyboard presented on the display, and wherein the output determined information item is output in one or more tiles in a row above the virtual keyboard.

6. The method of claim 1, wherein the computing device comprises a mobile computing device having a display and a virtual keyboard presented on the display, and wherein the received one or more user inputs comprise text typed using the virtual a keyboard of the computing device.

7. The method of claim 6, further comprising:
determining an appropriate quantity of the text to analyze based on at least one of: a set quantity parameter and machine learning based on the determined situational context.

8. The method of claim 6, further comprising:
extracting text features from the text, wherein the text features comprise one or more of: subjects, natural language features, actions, and intention.

9. The method of claim 1, wherein the received one or more user inputs comprise a voice command to the computing device.

10. The method of claim 1, wherein the sensor data comprises at least one of: a time of day, a geo-location of the computing device, an orientation of the computing device, a local language used by the computing device, whether the computing device is moving, and information available from an operating system of the computing device.

11. The method of claim 3, wherein utilizing the machine learning model to determine the situational context further comprises:
receiving, by a context creator module, information from one or more sources; and
generating, by the context creator module, a situational context model in response to a trigger, wherein the generated situational context model contains an assessment of the situational context.

12. The method of claim 11, wherein the trigger is at least one of: a scheduled process and an external event.

13. The method of claim 11, wherein the received information from the one or more sources comprises one or more machine learning models and one or more manually defined heuristics and rules.

14. The method of claim 13, wherein the received information from the one or more sources further comprises at least one of: sensor data from the one or more sensors, a database of historical recorded actions by a user, and a set of reference data.

15. The method of claim 11, further comprising, prior to outputting information items:
calculating a conversion likelihood for the determined at least one information item of the one or more information items.

16. The method of claim 15, wherein the calculated conversion likelihood corresponds to a probability of a user purchasing the one or more information items associated with the determined situational context.

17. The method of claim 15, further comprising:
comparing the calculated conversion likelihood to a threshold; and
waiting to receive one or more additional user inputs into the computing device if the calculated conversion likelihood is less than the threshold.

18. The method of claim 15, wherein calculating the conversion likelihood further comprises:
receiving, by a probability calculation module, inputs from one or more sources; and
generating, by the probability calculation module, a conversion likelihood in response to a trigger, wherein the conversion likelihood comprises a measure of the likelihood of the user to click or act on the determined at least one information item.

19. The method of claim 18, wherein the inputs from one or more sources comprise: the generated situational context model, external historical data, user historical data, and a request from the trigger.

20. The method of claim 19, wherein the external historical data comprises a dataset containing prior scenarios and outcomes from other users, and wherein the user historical data comprises a dataset containing prior scenarios and outcomes from the user.

21. The method of claim 1, further comprising:
updating the local content database of the computing device from a global content database of a cloud computing environment via a one-way sync from the cloud computing environment to the computing device, wherein all user data on the computing device remains secure on the computing device and all user data on the device is not transferred to the cloud computing environment.

22. The method of claim 21, wherein updates to the local content database use delta-change sets, wherein the updates to the local content database comprise only additions or removals of digital content in the local content database based on a comparison of a current version of digital content contained by the local content database with digital content present in the global content database.

23. The method of claim 21, wherein updates to the local content database are based on at least one of: a strength of a network used by the computing device to communicate with the cloud computing environment, a battery life of the computing device, and an activity on the computing device.

24. The method of claim 22, wherein updating the local content database of the computing device further comprises:
determining a suitable time for updating the local content database based on at least one of: a strength of a network used by the computing device to communicate with the cloud computing environment, a battery life of the computing device, and an activity on the computing device.

25. The method of claim 1, further comprising:
mapping a recent browser history of the computing device to one or more brand categories by reference to the local content database.

26. A computing device, comprising:
a memory configured to store a machine learning model, a local content database configured to store digital content for one or more items, and one or more computer-executable instructions; and
at least one processor in communication with the memory and configured to execute the computer-executable instructions to:
receive one or more user inputs into the computing device;
receive current system parameters comprising at least one of: sensor data from one or more sensors in the computing device and information associated with a process on the computing device;
utilize, at the computing device, the machine learning model to determine a situational context based on the received one or more user inputs and the received system parameters;
based on the determined situational context, determine, at the computing device, one or more information items stored in the local content database.

27. The computing device of claim 26 wherein the processor is further configured to:
output, via an interface, information of the at least one determined information item of the one or more information items in real-time while receiving the one or more user inputs into the computing device, wherein the real-time output uses edge computing on the computing device.

28. The computing device of claim 26, wherein to determine the situational context, the processor is further configured to:
receive, by a context creator module, information from one or more sources, wherein the received information from one or more sources comprises at least one of: one or more machine learning models, one or more manually defined heuristics and rules, sensor data from one or more sensors, a database of historical recorded actions by a user, and a set of reference data; and
generate, by the context creator module, a situational context model in response to a trigger, wherein the generated situational context model contains an assessment of the situational context, wherein the trigger is at least one of: a scheduled process and an external event.

29. The computing device of claim 28, wherein prior to outputting the information, the processor is further configured to:
receive, by a probability calculation module, inputs from one or more sources, wherein the inputs from one or more sources comprise: the generated situational context model, external historical data, user historical data, and a request from the trigger, wherein the external historical data comprises a dataset containing prior scenarios and outcomes from other users, and wherein the user historical data comprises a dataset containing prior scenarios and outcomes from the user; and
generate, by a probability calculation module, a conversion likelihood in response to a trigger, wherein the conversion likelihood comprises a measure of the likelihood of the user to click or act on the determined at least one item.

30. The computing device of claim 26, wherein to determine the one or more information items from the local content database, the processor is further configured to:
determine, using the machine learning model, a conversion likelihood probability of the situational context;
compare the conversion likelihood probability of the situational context with a threshold;
determine at least one item associated with the current situational content, when the conversion likelihood probability of the situational context is more than the threshold; and
output, via the output interface, information of the at least one information item associated with the situational context in real-time.

31. The computing device of claim 26, wherein the processor is further configured to:
update the local content database of the computing device from a global content database of a cloud computing environment via a one-way sync from the cloud computing environment to the computing device, wherein user data remains on the computing device, wherein the updates to the local content database comprise only additions or removals of digital content in the local content database based on a comparison of a current version of digital content contained by the local content database with digital content present in the global content database.
